(19) United States
(12) Patent Application Publication
(10) Pub. No.: US 2005/0073382 A1
(43) Pub. Date: Apr. 7, 2005

(54) Shielded inductors

(76) Inventor: Samuel Kung, Fullerton, CA (US)

Correspondence Address: Eric K. Satermo;Registered Patent Agent, P.O. Box 19099, Irvine, CA, 92623-9099, US

(21) Appl. No.: 10/997,590

(22) Filed: Nov. 23, 2004

Related U.S. Application Data
(63) Continuation of application No. 10/163,259, filed on Jun. 4, 2002, now Pat. No. 6,847,280.

(51) Int. Cl. H01F 27/02

(52) U.S. Cl. 336/83

(57) ABSTRACT

An inductor includes a core, a coil disposed about the core, and a shield. The shield and the core are connected to each other so that a closed magnetic loop is formed. The core may be a single piece or made up of a pair of core segments. The shield may include two halves or portions or may include a cover with a base. The core may be unitary with the shield at one or both ends thereof. In embodiments where the shield includes two portions, the portions may have substantially identical geometry and dimensions.

### CROSS REFERENCE TO RELATED APPLICATION

This application is a continuation application of U.S. application Ser. No. 10/163,259 filed Jun. 4, 2002.

### BACKGROUND OF THE INVENTION

1. Field of the Invention

The present invention relates to electrical components, specifically inductors.

2. Description of the Related Art

The desirability for electrical components that are smaller in size but that have better electrical properties never fades. Often there are trade offs when it comes to designing such components. For example, when size is reduced, one or more of the electrical properties is adversely affected.

In the case of inductors, electromagnetic interference (EMI) is one of the properties that is desirably minimized or eliminated. EMI is an unwanted electromagnetic signal which may degrade the performance of an electronic device. To reduce EMI effects caused by inductors, shields are placed about the inductor. Shielded inductors thereby require more space than unshielded types. In addition, the shields require grounding.

### BRIEF SUMMARY OF THE INVENTION

An inductor includes a core, a coil disposed about the core, and a shield. The shield and the core are connected to each other so that a closed magnetic loop is formed. The core may be a single piece or made up of a pair of core segments. The shield may include two halves or portions or may include a cover with a base. The core may be unitary with the shield at one or both ends thereof. In embodiments where the shield includes two portions, the portions may have substantially identical geometry and dimensions.

For a given energy storage capability, the inductor of the invention greatly improves upon conventional inductors. For example, the inductor of the invention is able to store the same amount of energy at a volume of about 10 times less than conventional toroidal inductors. In addition, with ratio of width to length of the inductor of the invention may be on the order of 1 to 1, while such ratio for conventional toroidal inductors is on the order of 2 to 1.

Other features and advantages of the present invention will become apparent to those skilled in the art from a consideration of the following detailed description taken in conjunction with the accompanying drawings.

### BRIEF DESCRIPTION OF THE SEVERAL VIEWS OF THE DRAWINGS

FIG. 1 is a perspective view of a shielded inductor;

FIG. 2 is an exploded perspective view of a shielded inductor;

FIG. 3 is an exploded side view of a shielded inductor;

FIG. 4 illustrates a closed magnetic loop of a shield and a core of an inductor;

FIG. 5 is an exploded perspective view of a shielded inductor;

FIGS. 6A and 6B are side views of the inductor of FIG. 5;

FIG. 7 is an exploded perspective view of a shielded inductor;

FIG. 7A is a perspective view of the inductor of FIG. 7;

FIG. 8 is an exploded perspective view of a shielded inductor;

FIG. 8A is a perspective view of the inductor of FIG. 8; and

FIG. 9 illustrates dimensions of a shielded inductor.

### DETAILED DESCRIPTION OF THE INVENTION

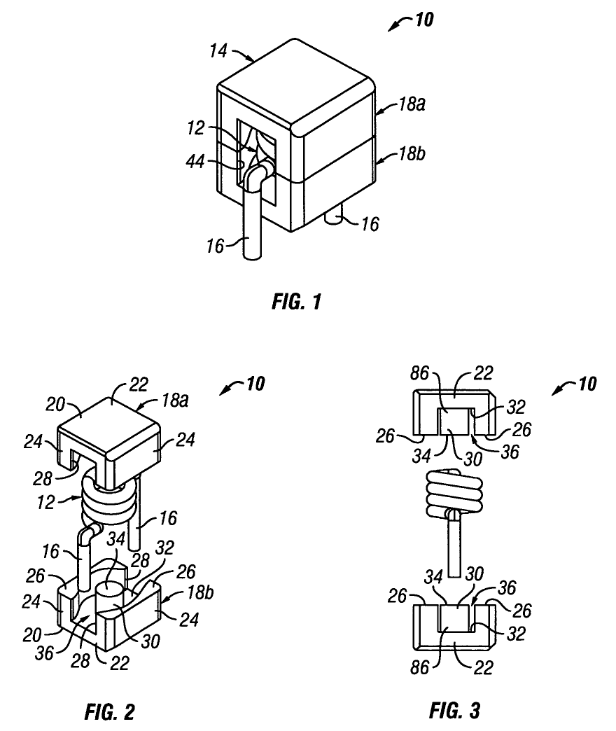

Referring to FIGS. 1 and 2 in detail, an inductor 10 includes a coil 12 and a shielded core 14. The coil 12 may have a pair of terminals 16, and the shielded core 14 may include a first portion 18a and a second portion 18b.

As shown in FIG. 2, each portion 18 may include a housing 20 having an end wall 22 and a side wall 24. In the embodiment shown, the side wall 24 of each housing 20 may have a mating edge 26, which is also shown in FIG. 3. In addition, a pair of notches 28 may be formed in the side wall 24 for receiving a terminal 16 of the coil 12.

The housing of each portion 18 of the core 14 may also include a core segment 30, which is shown clearly in FIG. 3. The core segment 30 may be disposed on an inner surface 32 of the end wall 22. Each core segment 30 may have an end face 34. In a number of embodiments, a seat 36 may be defined within each portion 18, for example, the between the side wall 24 and the core segment 30 for receiving the coil 12.

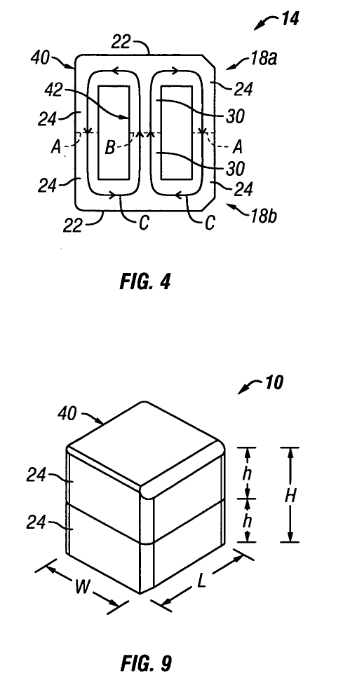

With additional reference to FIG. 4, when the first and second portions 18a and 18b are engaged together with the coil 12 received by the seats 36, the mating edges 26 of the side walls 24 of the housings 20 mate with each other as shown by the dashed lines indicated at A to form a magnetically continuous shield 40. In addition, the end faces 34 of the core segments 30 contact each other as shown by the dashed line indicated at B to form a magnetically continuous core 42. Accordingly, a closed magnetic loop is formed by the shield 40 and the core 42, as indicated by magnetic flux lines C. When mounted in an electric circuit, the shield 40 does not require grounding.

As shown in FIG. 1, when the portions 18 are engaged, the notches 28 of the housing 20 of the first portion 18a respectively align with the notches 28 of the housing 20 of the second portion 18b to form a pair of apertures 44 in the shield 40 (only one of the apertures is shown in FIG. 1). Accordingly, with the coil 12 received by the seats 36 about the core 42, the terminals 16 may respectively project through the apertures 44 of the shield 40.

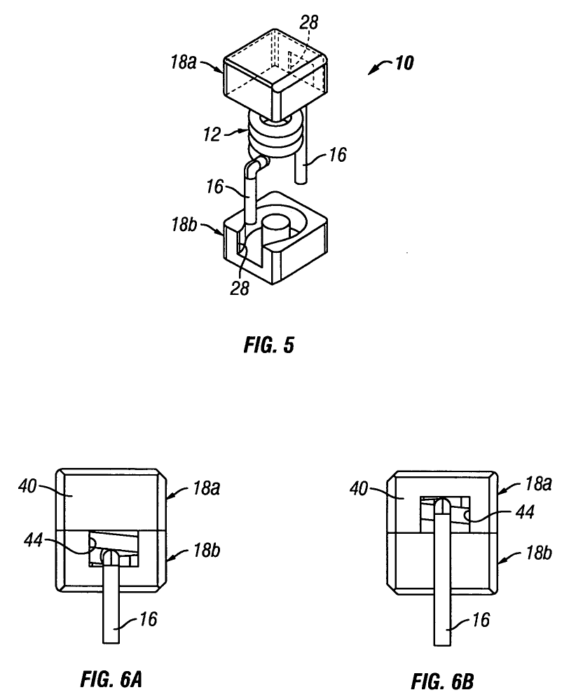

In a number of embodiments, for example, as shown in FIG. 5, a single notch 28 may be formed in the side wall 24 of each portion 18. Accordingly, when the portions 18 are secured as shown in FIGS. 6A and 6B, a pair of apertures 44 are formed in the shield 40 for respectively receiving the terminals 16 of the coil 12.

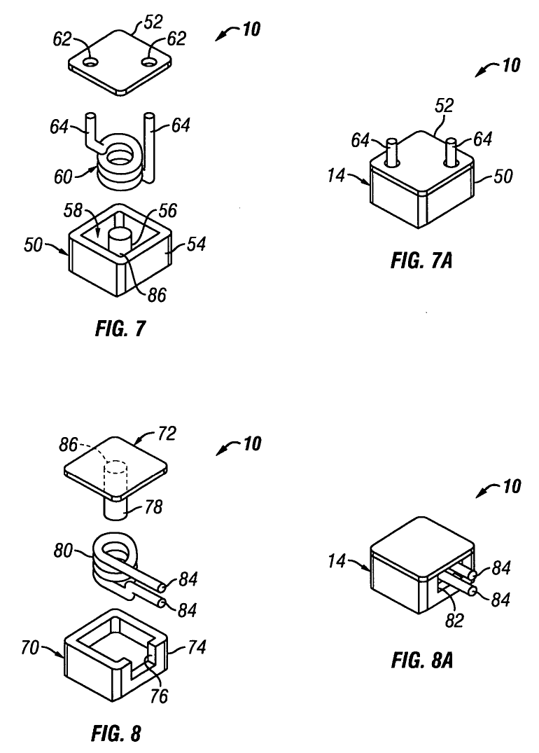

In other embodiments such as those shown in FIG. 7, the shielded core 14 may include a first portion such as a base 50 and a second portion such as cover 52. The base 50 may include a side wall 54 and a core 56, with a seat 58 for receiving a coil 60 defined between the side wall 54 and the core 56. The cover 52 may include a pair of apertures 64 for respectively receiving terminals 64 of the coil 60 when the coil is received in the seat 58. When the cover 52 is mated with the base 50 and the core 56 as shown in FIG. 7A, a closed magnetic loop is formed by the base 50, the cover 52, and the core 56, with the terminals 64 projecting through the apertures 64.

In still other embodiments, a single aperture may be utilized. For example, as shown in FIG. 8, the shielded core 14 may include a first portion such as a base 70 and a second portion such as cover 72. The base 70 may include a side wall 74 with a notch 76 formed therein. A core 78 is provided and may be disposed on either the base 70 or the cover 72; in the embodiment shown, the core 78 is attached to the cover 72. When the cover 72 is mated with the base 70 with a coil 80 received about the core 78 as shown in FIG. 8A, an aperture 82 is formed, and a closed magnetic loop is formed by the base 70, the cover 72, and the core 78, with terminals 84 of the coil 80 projecting through the aperture 82.

In a number of embodiments, the dimensions of the inductor 10 are minimized while still maintaining desirable electrical characteristics. As an example, with reference to FIG. 9, an overall height H of the shield core 40 may be less than about 10 mm, with the side wall 24 of each housing having a height h of less than about 5 mm. In addition, the shielded core 40 may have a length L of less than about 10 mm and a width W of less than about 10 mm. Accordingly, in embodiments where the dimensions are approximately equal, a ratio of width W to length L is on the order of 1 to 1. In other embodiments, the width-to-length ratio is less than about 1.5 to 1.

As another example, one of the electrical properties for inductors is energy storage, which is a determined by the equation E=½LI², where L is inductance and I is current DC. A desirable characteristic of inductors is volume versus energy storage. If each of the dimensions (i.e., height H, length L, and width L) of the inductor 10 is about 6.8 mm, then a volume of the shield core 40 is about 310 mm³. At these dimensions, the inductor 10 may have an inductance of about 400 nH (nanohenrys) at a frequency of about 100 kHz and a current of about 20 amperes DC, and an energy storage of 80 μJ (microjoules). For comparison purposes, a conventional toroidal inductor capable of storing the same amount of energy would need to have a length of about 20 mm, a width of about 20 mm, and a height of about 8 mm, thereby having a volume of about 3,200 mm³. Accordingly, the inductor 10 with a columnar core 42 and closed magnetic loop of the present invention reduces the volume by over 10 times for the same energy storage capability.

In a number of embodiments, such as that shown in FIGS. 1, 2, and 3, the first and second portions 18a and 18b of the shielded core 14 have substantially identical geometry and substantially equal dimensions. Accordingly, during manufacturing, only a single die, mold, or cast (depending upon the manufacturing process) needs to be made to produce the portions 18 of the shielded core 14 with, e.g. powder iron, thereby reducing costs. In addition, the core segment 30 and the housing 20, specifically, the end wall 22, of each portion 18 may be of unitary construction, thereby eliminating manufacturing processes dedicated to producing a separate core and attaching such core to a shield. In other words, an end 86 (see FIGS. 3, 7, and 8) of the core 78 or core segment 30 may be unitary with the shield 14.

With regard to manufacturing, to fabricate the inductor 10, the coil 12 may be positioned in the seat 36 of the housing 20 of one of the portions 18 with the terminals aligned with the notch or notches 28. The other portion may then be positioned thereon, with the mating edges 26 and the end faces 34 respectively contacting. The portions 18a and 18b may be secured together at the mating edges 26 of the side walls 24 with, for example, adhesive such as epoxy. Although the coil 12 may be would about the core, the coil 12 may be prefabricated, e.g., with an automatic winder, to reduce manufacturing costs.

Those skilled in the art will understand that the preceding exemplary embodiments of the present invention provide the foundation for numerous alternatives and modifications thereto. These other modifications are also within the scope of the present invention. Accordingly, the present invention is not limited to that precisely as shown and described in the present invention.

1. An inductor comprising:
a core; and
a shield connected to core such that a closed loop is formed by the shield and the core.

2. The inductor of claim 1 further comprising a coil disposed about the core.

3. The inductor of claim 2 wherein:
the coil has a pair of terminals; and
the shield has a pair of apertures through which the terminals project.

4. The inductor of claim 1 wherein the shield includes a base and a cover with the core being disposed therebetween.

5. The inductor of claim 4 wherein the base includes a seat for receiving a coil.

6. The inductor of claim 4 wherein the base includes a side wall with a notch.

7. The inductor of claim 4 wherein the core has an end that is unitary with the cover.

8. The inductor of claim 4 wherein the core has an end that is unitary with the base.

9. The inductor of claim 4 wherein the cover includes a pair of apertures.

10. A shielded core for an inductor, the shielded core comprising:
a cover;
a base with a seat for receiving a coil;
a core disposed between the cover and the base such that a closed loop is formed by the cover, the base, and the core.

11. The shielded core of claim 10 wherein the base includes a side wall with a notch.

12. The inductor of claim 10 wherein the core has an end that is unitary with the cover.

13. The inductor of claim 10 wherein the core has an end that is unitary with the base.

14. The inductor of claim 10 wherein the cover includes a pair of apertures.

15. An inductor comprising:
a shielded core including a core, a pair of end walls, and at least one side wall disposed together such that a closed loop is formed by the core, the end walls, and the at least one side wall; and
a coil disposed about the core.
